(19) United States
(12) Patent Application Publication
(10) Pub. No.: US 2025/0300814 A1
(43) Pub. Date: Sep. 25, 2025

(54) SYSTEMS AND METHODS FOR EXTENDING AUTHENTICATION

(71) Applicant: MASTERCARD INTERNATIONAL INCORPORATED, PURCHASE, NY (US)

(72) Inventors: Kaushal Shetty, O'Fallon, MO (US); Balu Ramamoorthy, Pune (IN)

(21) Appl. No.: 19/086,285

(22) Filed: Mar. 21, 2025

Related U.S. Application Data
(60) Provisional application No. 63/569,064, filed on Mar. 22, 2024.

(51) Int. Cl. H04L 9/08; H04L 9/32

(52) U.S. Cl. CPC H04L 9/0825; H04L 9/3247

(57) ABSTRACT

Systems and methods are provided for extending authentication from a third party. An example computer-implemented method includes receiving an authentication request associated with a transaction to an account, from an access control server (ACS), where the authentication request includes an account number for the account, and requesting authentication of a user of the account, from an issuer of the account, at a mobile device. The method also includes receiving an authentication result, from the mobile device, which is signed by a private key, and verifying the signed authentication result, based on a public key associated the mobile device. The method then includes returning the authentication result to the ACS, in response to the authentication request.

### CROSS-REFERENCE TO RELATED APPLICATION

This application claims the benefit of, and priority to, U.S. Provisional Application No. 63/569,064, filed Mar. 22, 2024. The entire disclosure of the above application is incorporated herein by reference.

### FIELD

The present disclosure generally relates to systems and methods for use in extending authentication, from a third party, in connection with network traffic.

### BACKGROUND

This section provides background information related to the present disclosure which is not necessarily prior art.

Users are known to interact with different entities, through networks, for a variety of reasons. From time to time, as part of the interactions, the parties desire to authenticate the users to confirm identities of the users, for example, to ensure the users are the correct users, as compared to different users claiming to be the users, etc. In one example, a party may leverage fast identity online (FIDO) as a form of authentication. As part of FIDO authentication, the party enrolls the user, with a private key generated and stored in a device of the user (e.g., a smartphone, etc.) and a public key, which is shared with and stored by the party. Subsequently, the user is authenticated for an interaction with the party based on a signed message from the device being authenticated by the public key held by the party.

Separately, processing networks often provide enhanced authentication techniques in processing transactions, via utilization of the 3-D Secure™ specification, which relies on access control servers (ACSs) associated with the issuers to perform authentication. In connection therewith, the 3-D Secure™ specification is known to be used for certain specific transactions.

### BRIEF DESCRIPTION OF DRAWINGS

The drawings described herein are for illustrative purposes only of selected embodiments and not all possible implementations, and are not intended to limit the scope of the present disclosure:

FIG. 1 illustrates an example system for use in extending authentication for network traffic;

FIG. 2 is a block diagram of an example computing device that may be used in the system of FIG. 1; and

FIG. 3 illustrates an example method that may be implemented via the system of FIG. 1, for extending authentication for network traffic.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Through FIDO authentication, parties develop connections with the users, which are specific to the parties, and generally limited to proving identity authentication to those parties. That is, for example, enrollment among the parties may be more or less stringent depending on the reason for the authentication of the users. As such, one party may not accept the authentication by another party's FIDO authentication enrolled user. This limits the use of the FIDO authentication from party to party, and also to different functionality. For example, FIDO authentication for an application of one party may not be suited to provide transaction authentication in general (or for another party), etc.

Uniquely, the systems and methods herein provide for extending authentication, from a third party, for network traffic. That said, it should be understood that while some of the embodiments herein are generally described with reference to biometric transactions, the authentication described in the present disclosure may similarly be provided and/or implemented as part of other purchase or non-purchase interactions. Further, the authentication described herein may follow, for example, the 3-D Secure™ protocol/specification flow, as described, or not.

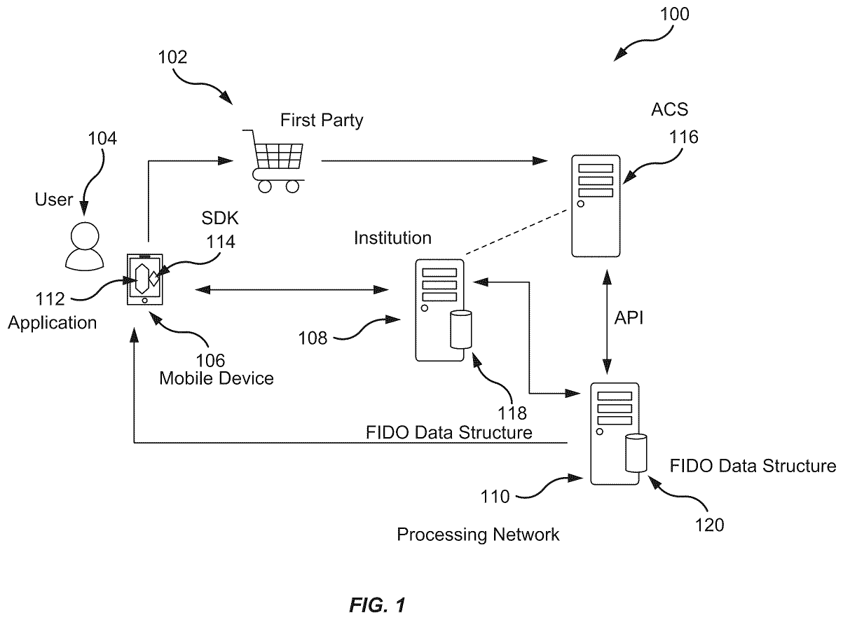

FIG. 1 illustrates an example system 100 for leveraging fast identity online (FIDO) authentication for biometric transactions, and which is consistent with the EMV® 3-D Secure™ protocol/specification, for example. It should be appreciated, however, that not all details of the EMV® 3-D Secure™ protocol/specification are discussed herein, as such information is readily understood by those skilled in the art. In addition, the illustrated system 100 includes a plurality of parties that interact with each other by exchanging multiple, specifically formatted messages over secure communication channels (e.g., as defined in the EMV® 3-D Secure™ protocol/specification (see, e.g., https://www.emvco.com/emv-technologies/3d-secure/; etc.), etc.).

As shown in FIG. 1, the system 100 includes a first party 102, a user 104 who, in this example, interactions with the first party 102 for the purchase of one or more products (e.g., goods, services, etc.), and a mobile device 106 associated with the user 104. In this example, the first party 102 may be understood to be a merchant. That said, in other examples, the user 104 may interact with the first party 102 (which may or may not be a merchant) independent of purchasing any products while still invoking the authentication features described herein (e.g., the user 104 may interact with the first party 102 to gain access to content and/or services provided by the first party 102, etc.).

The first party 102 includes, in this example embodiment, a virtual merchant having a virtual merchant location, such as, for example, a website, a network-based application, etc., which is accessible by users (e.g., the user 104, etc.), via a computing device (e.g., the mobile device 106 associated with the user 104, etc.). The merchant virtual location may be managed and/or provided directly by the first party 102, or it may be managed and/or provided by another entity on behalf of the first party 102, etc. In general, the merchant virtual location permits the user 104 to browse and/or search among one or more products (e.g., good, services, etc.) and to select product(s) for purchase from the first party 102 (e.g., as part of an e-commerce interaction, as part of a card-not-present interaction (e.g., a token-based interaction, etc.), etc.). In addition, in this example embodiment, the first party 102 may include a physical brick-and-mortar location, at which the user 104 may also physically enter to browse and/or search among one or more products (e.g., good, services, etc.) and to select product(s) for purchase from the first party 102.

The mobile device 106 may include, for example, a tablet, a smartphone, a laptop, or other device, which enables the user 104 to interact and/or communicate with the merchant virtual location. That said, the mobile device 106 may be an immobile device in other embodiments (e.g., a desktop computer, etc.).

In this example embodiment, the system 100 implements the 3-D Secure™ specification (as part of enhanced authentication of transactions). In connection therewith, the system 100 further includes a merchant plug-in (MPI) (not shown) and an access control server (ACS) 116, which are configured to cooperate to provide enhanced authentication of the user 104 in the context of an interaction at the first party 102, as described more below. The MPI is associated with and/or is included in the first party 102, and/or executed by a computing device of the first party 102. That said, it should be appreciated that the MPI may be one or more separate servers and/or services, which are associated with the first party 102, yet suitable to participate in the enhanced authentication described herein, or otherwise.

The system 100 also include an issuer institution 108 (e.g., an issuer, etc.) and a processing network 110.

The issuer institution 108 is configured to issue payment accounts to users, including the user 104, etc. The payment accounts may include credit accounts, debit accounts, prepaid account, etc. The payment accounts, in turn, are then used by the users to fund transactions, for example, with the first party 102. As shown, the issuer institution 108 is further associated with a FIDO data structure 118, which includes profiles for users, as explained in detail below.

The processing network 110 is configured to coordinate messaging between the issuer institution 108 and an acquirer (not shown) associated with the first party 102. The messaging is used to authorize, clear, and settle transactions between the users and the first party 102, and in particular, between accounts issued by the issuer institution 108 and the acquirer. What's more, the ACS 116 is provided by the processing network 110 to be included in, or associated with, the issuer institution 108, for example, as defined by the 3-D Secure™ specification (as generally indicated by the dotted line in FIG. 1). As shown, the processing network 110 is further associated with a FIDO data structure 120, which includes profiles for users, as explained in detail below.

It should be appreciated that while the issuer institution 108 and the processing network 110 are illustrated as a single server, each may include multiple different computing devices, which are dedicated to different functions as explained below. It should be appreciated that the ACS 116 may likewise included multiple computing devices.

With continued reference to FIG. 1, in this example embodiment, the issuer institution 108 is configured to publish, provide, and/or otherwise make available an application 112. The application 112, in this example embodiment, is included in the mobile device 106, whereby the application 112 configures the mobile device 106 to operate consistent with the description herein. That is, for example, the mobile deice 106 is configured, by the application 112, to communicate with the issuer institution 108.

It should be appreciated that the application 112 may be associated with various functionalities such as, for example, permitting the user 104 to view information associated with an account issued by the issuer institution 108 (e.g., balance, payment dates, etc.), transfer funds, view rewards points, etc. It should be appreciated that the application 112 may include various other functionalities.

Further, in this example embodiment, the application 112 includes a software-development kit (SDK) 114, which is provided by the processing network 110. The SDK 114, as part of the application 112, configures the mobile device 106 to communicate with the processing network 110, consistent with the description below.

Based on the above, the system 110 is configured to leverage FIDO authentication in connection with transactions between the user 104 and the first party 102.

In particular, in this example embodiment, the user 104 initially launches the application 112 in the mobile device 106. In turn, the mobile device 106 is configured, by the application 112, to enroll the user 104 for authentication, and in particular, FIDO authentication. The enrollment may extend to the issuer institution 108 and to the processing network 110, or the enrollment, at least initially, may be limited to enrollment with issuer institution 108.

As part of the enrollment, the mobile device 106 is configured, by the application 112, to solicit information related to the user 104, including, for example, a name, and email address, a phone number, a mailing address, bank information (e.g., account numbers, etc.), etc., which the user 104 provides. In addition, the mobile device 106 is configured, by the application 112, to collect information from the mobile device 106, including, for example, a device ID (e.g., MAC address, IP address, electronic serial number (ESN), etc.).

Further, the mobile device 106 is configured, by the application 112, to generate a first private-public key pair and to store the private key from the first key pair in a secure element of the mobile device 106.

The mobile device 106 is configured, by the application 112, to transmit the public key of the first key pair to the issuer institution 108, along with certain information related to the user 104 and the mobile device 106. The issuer institution 108, in turn, is configured to create a profile for the user 104, which includes the public key, and to store the user profile in memory.

As part of the enrollment of the user 104 with the application 112, or at a later time, the user 104 is given the option to enroll for biometric payment, whereby the mobile device 106 is enabled to participate in biometric transactions. In connection with the user 104 opting to enroll for biometric payment, the mobile device 106 is configured by the application 112 (specifically, the SDK 114), to generate a second private-public key pair and to store the private key from the second key pair in a secure element of the mobile device 106.

The mobile device 106 is configured, by the application 112, to transmit the public key of the second key pair to the processing network 110, along with certain information related to the user 104 and the mobile device 106. The processing network 110, in turn, is configured to create a profile for the user 104, which includes the public key from the second key pair, and to store the user profile in memory.

It should be appreciated that in various embodiments, the FIDO authentication may be limited to the issuer institution 108, whereby the second key pair is omitted. That is, as explained in more detail below, the issuer institution 108 is configured to participate in FIDO authentication of the user 104 in connection with biometric payment or other payment methods.

In connection with the above, the issuer institution 108 is configured to append a mapping between the account issued by the issuer institution 108 and enrollment in FIDO authentication with the issuer institution 108, to a data structure included within the processing network 110. It should be appreciated that, from time to time, enrollment in FIDO authentication may be changed, whereby the issuer institution 108 is configured to delete a mapping from the data structure included in the processing network 110.

Subsequently, following such enrollment, in connection with a biometric transaction by the user 104, the first party 102 is configured to compile an authentication requests and to transmit the authentication request, via the MPI and a directory server (not shown) associated with the processing network 110, to the ACS 116. The authentication request includes account data for the payment account issued by the issuer institution 108 (e.g., PAN, token, etc.) and presented, for example, to the first party 102 as part of the biometric transaction.

In response, the ACS 116 is configured to determine whether the account is enrolled for FIDO authentication with the processing network 110. The processing network 110 is configured to access the data structure 120 and to search for the account. When the account is included in the data structure 120, the processing network 110 is configured to retrieve a list of the devices enrolled for FIDO authentication (e.g., the mobile device 106, etc.). The list of devices may be based on a device ID specific to the particular device. The processing network 110 is configured to provide the list of devices back to the ACS 116. The ACS 116 is configured to cooperate with the first party 102, for example, to solicit a selection of one of the devices included in the listing of devices from the user 104, via the mobile device 106.

It should be appreciated that where only one device is registered, or a default device is designated for authentication, the above listing being transmitted back to the ACS 116 may be omitted.

In response to user selection, in this example embodiment, of the mobile device 106, the ACS 116 is configured to request authentication from the processing network 110.

The processing network 110 is configured to facilitate authentication of the user 104, which may be through the mobile device 106, alone or in combination with one or more other devices.

In particular, for a push notification example, the processing network 110 is configured to submit a request to the issuer institution 108 for a FIDO authentication. The request includes the device ID of the device selected by the user 104.

In turn, the issuer institution 108 is configured to retrieve a user profile for the device ID and to transmit a request for authentication for the transaction, as a push notification, to the user 104, at the mobile device 106, via the application 112. In response, the mobile device 106 is configured, by the application 112, to display a banner indicative of the authentication request and to further solicit an authentication input from the user 104. The authentication input may include a password, PIN, biometric, etc., which may be verified at the mobile device 106, etc. For example, the mobile device 106 may be configured to verify a biometric against a reference biometric in the mobile device 106. When the input is provided by the user 104, the mobile device 106 is configured, by the application 112 (and specifically the SDK 114), to compile an authentication result indicating a successful authentication based on the authentication input, to sign the authentication result with the private key from the second key pair, and to transmit the authentication result to the processing network 110.

In turn, the processing network 110 is configured to verify the authentication result based on the public key from the second key pair included in the FIDO data structure 120, and, when verified, to provide the authentication result back to the ACS 116.

In a QR code example, where the transaction is initiated through a browser of the mobile device 106 (or application thereof) (or the browser of another computing device associated with the user 104 (e.g., a laptop, a desktop computer, etc.), for example, the processing network 110 is configured to transmit a request for authentication to the user 104 at the browser (or application). In turn, the mobile device 106 (or other computing device) is configured to display the QR code to the user 104 through the browser (or application). The user 104 then uses a different registered device (e.g., a smartphone, the mobile device 106, etc.) (or even the same device) to capture the QR code. When a different mobile device is used, it should be understood that the different device is also registered, with the FIDO data structure 120 of the processing network 110. The mobile device 106 (or different registered device) (along with the browser or application) is then configured to compile an authentication result indicating a successful authentication, to sign the authentication result with the private key from the second key pair (or key pair registered with the processing network 110), and to transmit the authentication result to the processing network 110.

In turn, the processing network 110 is configured to verify the authentication result based on the public key from the second key pair included in the FIDO data structure 120, and, when verified, to provide the authentication result back to the ACS 116.

In a operating system example, which leverages “Windows Hello” by MICROSOFT or other similar scheme, where the transaction is initiated through a browser of the mobile device 106, for example, the processing network 110 is configured to transmit a request for authentication to the mobile device 106. In turn, the mobile device 106 is configured to display the operating system-based authentication request to the user 104. The user 104 then uses the mobile device 106, or a different mobile device (e.g., a smartphone, etc.) to enter a code or other input as proof of authentication of the user 104. The code, for example, may be an authentication code generated by an authentication application on the mobile device 106. When the operating system-based authentication is satisfied, the mobile device 106 is then configured to compile an authentication result indicating a successful authentication, to sign the authentication result with the private key from the second key pair, and to transmit the authentication result to the processing network 110.

In turn, the processing network 110 is configured to verify the authentication result based on the public key from the second key pair included in the FIDO data structure 120, and, when verified, to provide the authentication result back to the ACS 116.

The above examples rely on the FIDO data structure 120 included in the processing network. Alternatively, the FIDO data structure 120, and associated registration, may be omitted in other embodiments. In particular, for example, where the FIDO authentication is limited to the issuer institution 108, the mobile device 106 is configured, by the application 112, to solicit an authentication input from the user 104. Then, when the input is provided by the user, the mobile device 106 is configured, by the application 112, to solicit an authentication result with the private key from the first key pair and to transmit the authentication result to the issuer institution 108. In turn, the issuer institution 108 is configured to verify the authentication result based on the public key from the first key pair, and when verified, to provide the authentication result to the processing network 110. The processing network 110 is configured to then provide the authentication result to the ACS 116.

Regardless of the path of the authentication result, when the user 104 is successfully authenticated, as indicated in the authentication result, the ACS 116 is configured to provide an authentication result back to the first party 102, via the MPI and the directory server, whereby the first party 102 is configured to proceed to request authorization of the transaction. That is, the authentication result from the ACS 116 includes an authentication value, which the first party 102 is configured to include in the authorization request. The authorization requests is then transmitted by the first party 102 to the issuer institution 108, via an acquirer associated with the first party 102 in the processing network 110.

The authentication value may be validated by the processing network 110 and the issuer institution 108. In connection therewith, the issuer institution 108 is configured to approve or decline the transaction, whereby the issuer institution 108 compiles and transmits an authorization reply back to the first party 102, via the processing network 110 and the acquirer. The first party 102 is then permitted to deliver the one or more products to the user 104, when the transaction is approved, or to seek an alternative form of payment, when the transaction is declined.

The parts of system 100 are coupled in communication through one or more networks, whereby messaging (e.g., requests, replies, responses, etc.), as described herein (and indicated by arrowed lines), are permitted.

The network(s) may each include, without limitation, one or more local area networks (LANs), wide area networks (WANs) (e.g., the Internet, etc.), mobile networks, virtual networks, other networks as described herein, and/or other suitable public and/or private networks capable of supporting communication among two or more of the illustrated parts, or even combinations thereof. In one example, a network includes multiple networks, where different ones of the multiple networks are accessible to different ones of the illustrated components in FIG. 1.

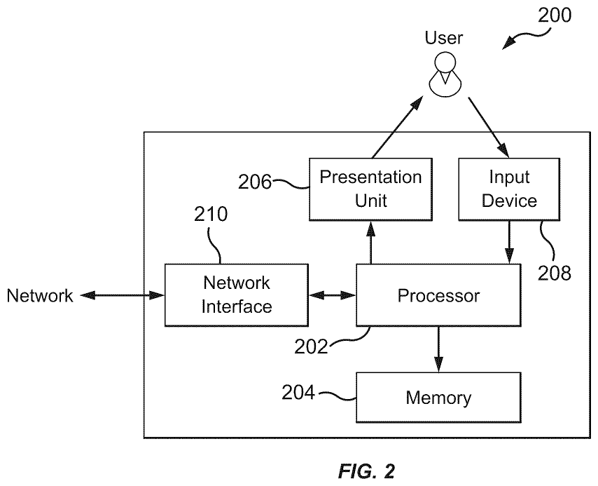

FIG. 2 illustrates example computing device 200, which may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. With that said, the system 100 should not be considered to be limited to the computing device 200, as described below, as different computing devices and/or arrangements of computing devices may be used. In addition, different components and/or arrangements of components may be used in other computing devices.

It should be appreciated that each of the first party 102, the mobile device 106, the issuer institution 108, the processing network 110, and the ACS 116, etc., in the system 100 are implemented herein in one or more computing devices, such as computing device 200 illustrated in FIG. 2. In connection therewith, the one or more computing devices are each in communication with one or more other entities via at least one of the networks described herein. In general, each of the paths included in FIG. 1, along which, or via which, messages are exchanged in the above description, are representative of the network(s).

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, age verification signals, birthdates, transaction IDs, account numbers (e.g., PANs, etc.), and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, and may effectively transform the computing device 200 into a special purpose computing device. It should be appreciated that the memory 204 may include a variety of different memories, each implemented in one or more of the functions or processes described herein.

In the example embodiment, the computing device 200 also includes a presentation unit 206 that is coupled to the processor 202 (however, it should be appreciated that the computing device 200 could include output devices other than the presentation unit 206, etc.). The presentation unit 206 outputs information (e.g., confirmations of purchases, challenge questions, etc.), either visually or audibly to the user 104 or other information to other users associated with any of the entities illustrated in FIG. 1, at a respective computing device, etc. It should be further appreciated that various interfaces may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

In addition, the computing device 200 includes an input device 208 that receives inputs from users (i.e., user inputs) such as, for example, responses to challenge questions, checkout inputs, payment account credentials, etc., from the user 104 or other information from other users in the system, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein.

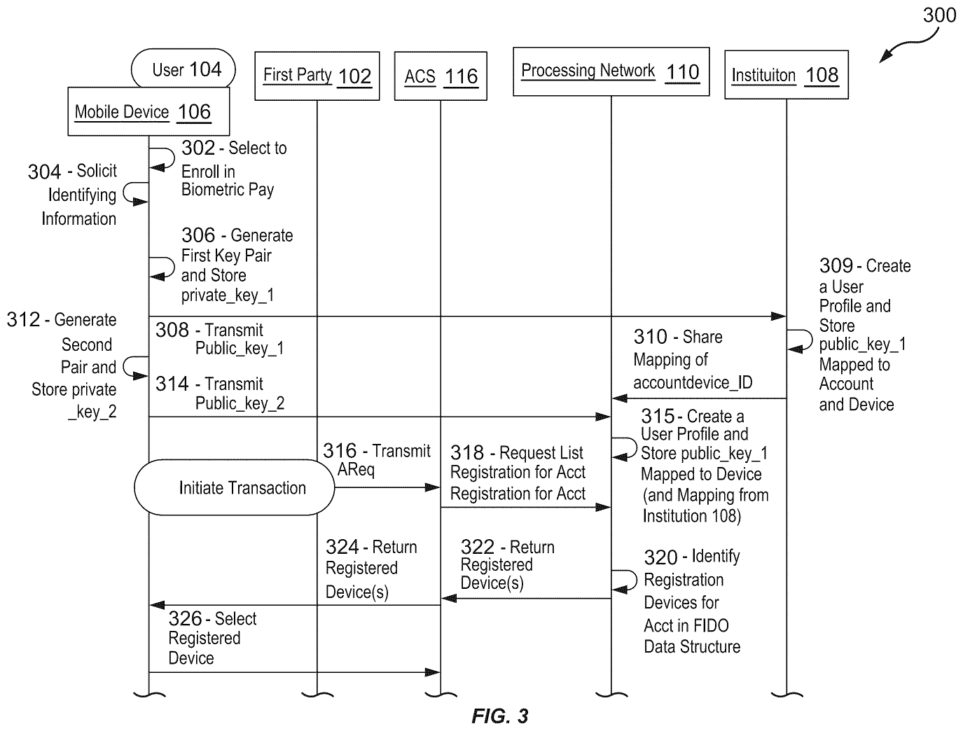

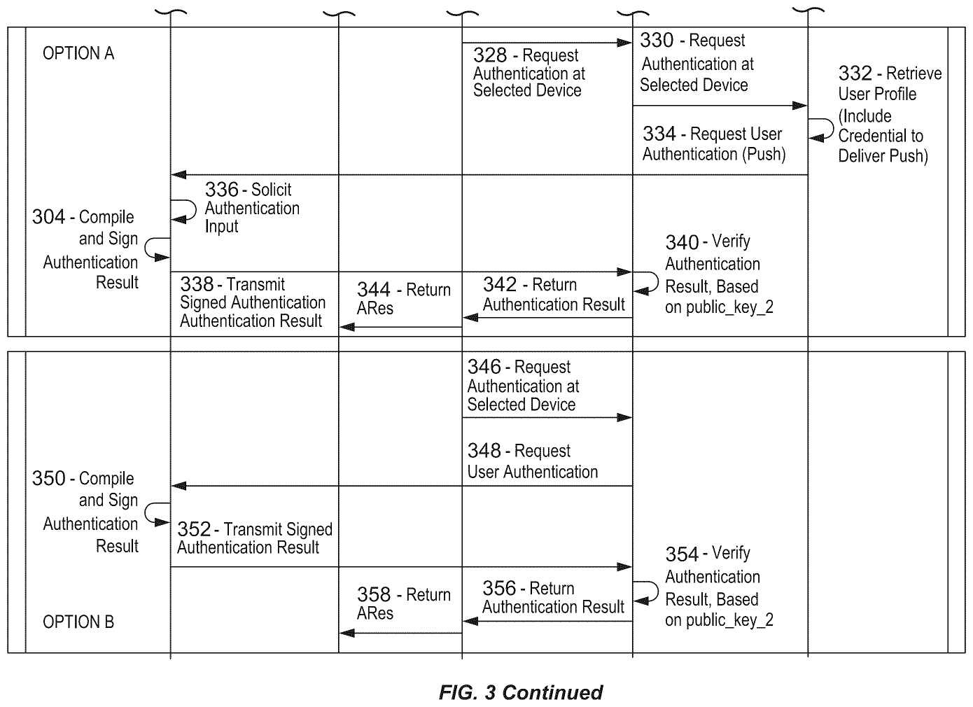

FIG. 3 illustrates an example method 300 for use in extending authentication from a third party (e.g., the issuer institution 108, etc.) in connection with transaction-specific network traffic. The example method 300 is described (with reference to FIG. 1) as generally implemented in the issuer institution 108, the processing network 110, and the ACS 116, and more generally, in the system 100, and with further reference to the computing device 200. As should be appreciated, however, the methods herein should not be understood to be limited to the example system 100 or the example computing device 200, and the systems and the computing devices herein should not be understood to be limited to the example method 300.

Initially, it should be appreciated that the user 104 is associated with an account issued by the issuer institution 108, and also, that the application 112 associated with the issuer institution 108 is installed and active in the mobile device 106 of the user 104. That is, for example, the user 104 may download (or has downloaded) the application 112 in order to view balances, make payments, or receive notifications, etc. relating to his/her account.

Upon access to the application 112, the mobile device 106 invites the user 104 to enroll for authentication, for example, with the issuer institution 108. In connection with enrolling for authentication, the user 104 may be permitted to more easily access the application 112. It should be appreciated that enrollment may be limited to the application 112, because a separate enrollment may be required to access functionality associated with the SDK 114. Specifically, for example, in order to enable biometric payments, the user 104 may be required to provide additional and/or different information to enroll the SDK 114.

In this example embodiment, the mobile device 106 additionally invites the user 104 to enroll for biometric pay, whereby the user 104 is required or requested to enroll with the SDK 114. Again, it should be appreciated that the user 104 may opt to enroll separately, or later, with the SDK 114 in other examples, or not at all (without affecting the general operation of FIDO authentication described herein). With reference to FIG. 3, the user 104 selects to enroll with the SDK 114, at 302, as a manner to enable FIDO authentication for biometric pay. It should be appreciated that the user 104 may opt to enroll in the SDK 114 for other functionality associated with the processing network 110 in other embodiments (e.g., digital identity, rewards, other payments, etc.).

In response, at 304, the mobile device 106 solicits identifying information from the user 104. This may include requesting the presentation of a physical document to be captured by a camera input device of the mobile device 106, along with presentation of the user's face to be captured by the camera input device as a facial image of the user 104. In such an example, the mobile device 106 may compare a biometric included in the physical document to the captured facial image of the user 104 to confirm the identifying information in the physical document is specific to the user 104.

It should be appreciated that various identifying information may be captured from the user 104, physical documents associated with the user 104, or third parties (e.g., a government agency, an identity provider, etc.), etc. In at least one embodiment, the identifying information is collected and/or provided from a different digital identity application (in the mobile device 106) or a digital identity provider (separate form the mobile device 106).

Upon receipt of the identifying information, for example, the mobile device 106 then generates, at 306, a first key pair, which includes a first private key, i.e., private_key_1, and a first public key, i.e., public_key_1. The mobile device 106 stores the first private key in a secure element (SE) of the mobile device (e.g., a key vault, etc.). At 308, the mobile device 106 transmits the first public key to the issuer institution 108. The mobile device 106 includes, with the first public key, account information related to the account issued to the user 104, by the issuer institution 108, and a device ID for the mobile device 106. The account information may include, specifically, an account number, an issuer ID, etc., and the device ID may include, without limitation, any of an ESN, a MAC address and IP address, phone number, etc. In response, the issuer institution 108 creates, at 309, a user profile for the user 104, which includes the first public key and a mapping between the device ID and the account issued to the user 104. The issuer institution 108 stores the first public key linked to the account and also the device ID in the FIDO data structure 118.

At 310, the issuer institution 108 shares the mapping of the device ID for the mobile device 106 and the account with the processing network 110.

Further, as shown in FIG. 3, the mobile device 106 generates, at 312, a second key pair, which includes a second private key, i.e., private_key_2, and a second public key, i.e., public_key_2. The mobile device 106 stores the second private key (private_key_2) in a secure element (SE) of the mobile device (e.g., a key vault, etc.). At 314, the mobile device 106 transmits the second public key (public_key_2) to the processing network 110, along with the device ID for the mobile device 106. At 315, the processing network 110 creates a user profile for the user 104, which includes the second public key linked to the device ID, etc. The processing network 110 stores the user profile in the FIDO data structure 120 and also stores the mapping of the device ID for the mobile device 106 and the account from the issuer institution 108 in the user profile in the FIDO data structure 120.

It should be appreciated that steps 304 to 315 may be repeated for additional devices, which the user 104 decides to enroll for FIDO authentication with the issuer institution 108, other issuers/institutions, and/or the processing network 110. The user 104 may, for example, decide to enroll a smartphone, a laptop, and a tablet where user 104 frequently uses the devices to either access the application 112 and/or to make biometric payments.

It should also be appreciated the enrollment with the processing network 110 may be omitted, whereby steps 312 and 314 are omitted from the method 300. In such an embodiment, the processing network 110 may rely on the FIDO authentication of the issuer institution 108 in connection with biometric pay, as explained above. As such, in the above example, the user 104 may only enroll the tablet for biometric pay, and not enroll the smartphone or the laptop for biometric pay, thereby omitting steps 312-314 for the later devices.

With reference again to FIG. 3, after the user 104 and the mobile device 106 are enrolled, the user 104 may decide to shop at the first party 102, and further, to purchase a product from the first party 102, via biometric pay.

In connection therewith, as shown in FIG. 3, a transaction is initiated and an authentication request (AReq) is transmitted, at 316, to the ACS 116 (e.g., from an MPI associated with the first party, the directory server associated with the processing network 110, consistent with the 3-D Secure™ protocol/specification flow, etc.). The authentication request includes an account indicator for the account issued to the user 104 by the issuer institution 108, where the account indicator may include a payment account number, token, etc. The authentication request also includes an identifier specific to the transaction (e.g., transaction ID, etc.). In turn, the ACS 116 requests, at 318, a list registration for the account from the processing network 110. That is, the ACS 116 relies on the challenge aspect of the above flow to seek an identity assertion for the user 104 from the processing network 110. The request for the list registration for the account includes the account indicator and the identifier of the transaction, and potentially, other data associated with the transaction (e.g., name of the first party 102, amount, etc.).

At 320, the processing network 110 identifies registered devices to the account in the FIDO data structure 120. In doing so, the processing network 110 searches for the account indicator, directly (where the indicator is an account number) or indirectly (after detokenizing the token (by the processing network 110 or a token provider), when the account indicator is a token) (e.g., in the data structure 120, etc.). It should be appreciated that the processing network 110 may identify more than one registered device for the account.

At 322, the processing network 110 returns the list of registered devices to the ACS 116. The ACS 116, in turn, cooperates with the first party 102 to display, at 324, the one or more registered devices to the user 104, at the mobile device 106. The user 104 then selects one of the register devices, which in this example, is the mobile device 106. The selection of the registered device is returned from the mobile device 106, via the first party 102, to the ACS 116, at 326.

With the registered device selected, the method 300 includes two options for FIDO authentication for the initiated transaction, each of which is designated in FIG. 3, as option A and option B.

In option A, the ACS requests, at 328, from the processing network 110, authentication of the user 104 at the mobile device 106, which is the selected registered device. The request includes the identifier of the selected device, i.e., the mobile device 106, and other data associated with the transaction (e.g., identifier of the transaction, name of the first party 102, amount, etc.).

In response, the processing network 110 requests authentication of the user 104, by the issuer institution 108, through a push notification to the mobile device 106, at 330. Based thereon, at 332, the issuer institution 108 retrieves the user profile from the FIDO data structure 118, which includes the device ID for the mobile device 106 and the appropriate credential to issue a push notification to the mobile device 106.

Next, at 334, the issuer institution 108 request user authentication as a push notification to the mobile device 106. The push notification may include data associated with the transaction (e.g., identifier of the transaction, name of the first party 102, amount, etc.).

At the mobile device 106, a flag or banner is displayed at the mobile device 106 to the user 104, which may include an indicator of a request for authentication and one or more details about the transaction for which authentication is requested (e.g., “Authenticate to make $50 purchase at Store,” etc.). When the user 104 selects the flag or banner, the mobile device 106 (via the application 112) solicits, at 336, an authentication of the user 104 for purposes of the initiated transaction. The authentication input may include a biometric, a PIN, a password, or suitable input, etc. for purposes of authentication. In response, the user 104 complies. The mobile device 106 captures the authentication input and authenticates the user 104 based on the authentication input. For example, the mobile device 106 may compare a facial image captured by a camera input device of the mobile device 106 with a reference biometric included therein. At 337, the mobile device 106 compiles and signs an authentication result with the second private key, i.e., private_key_2. The mobile device 106 then transmits the signed authentication result, via the SDK 114, to the processing network 110, at 338.

In response, the processing network 110 retrieves the user profile from the FIDO data structure 120 for the user 104 (e.g., based on the device ID, etc.) and verifies, at 340, the signature on the authentication result based on the second public key, i.e., public_key_2.

When the authentication result is verified, the processing network 110 returns, at 342, the authentication result to the ACS 116.

In turn, the ACS 116 returns, at 344, an authentication response or ARes to the first party 102, or specifically the MPI associated with the first party 102, via the directory server of the processing network 110. The first party 102 then continues to seek authorization of the transaction, whereby one or more values from the ARes is included in the authorization request which is transmitted to the issuer institution 108, via processing network 110.

In option B, the ACS requests, at 346, from the processing network 110, authentication of the user 104 at the mobile device 106, which is the selected registered device.

In response, the processing network 110 retrieves the user profile from the FIDO data structure 120, which includes the device ID for the mobile device 106. Then, at 348, the processing network issues the authentication request to the mobile device 106, which includes, in this example, a QR code to be displayed at the mobile device 106, where the QR code includes a link that takes (or directs) the user 104 to the application 112, and also includes the identifier of the transaction, and potentially, other data associated with the transaction, etc.

The mobile device 106 displays the QR code at a presentation unit of the mobile device 106. In this example, the mobile device 106 or another registered device then captures the QR code. That said, it should be appreciated that another device may be employed in other examples to either display the QR code, or to capture the QR code.

For example, where the QR code is scanned from the registered device (e.g., the mobile device 106 or another device, etc.), the registered device initiates the application 112 and asks the user 104 to authenticate using one or more biometrics of the user 104, or potentially, a passcode, PIN, or other authentication input, etc. The registered device (e.g., the mobile device 106 or another device, etc.) then accepts the authentication input, verifies the same (as applicable), and signs an authentication result (e.g., indicative of the successful authentication, etc.) with the second private key, i.e., private_key_2. The registered device then transmits the signed authentication result, via the SDK 114, to the processing network 110.

In response, the processing network 110 retrieves the user profile from the FIDO data structure 120 for the user 104 (e.g., based on the device ID, etc.) and verifies the signature on the authentication result based on the second public key, i.e., public_key_2. The processing network 110 then returns the authentication result back to the application 112 to be returned to the ACS 116, as explained below.

It should be appreciated that in lieu of the QR code, the processing network 110 may submit an operating system-based authentication to the mobile device 106, such as, for example, WINDOWS Hello, etc., similar to the push notification described above. Where the processing network 110 relies on an operating system-based authentication, the mobile device 106 generates the authentication result based on the authentication input from the user 104 (e.g., facial biometric, secure code from another device, etc.).

Once authenticated, at 350, the mobile device 106 compiles and signs an authentication result with the second private key, i.e., private_key_2. The mobile device 106 then transmits the signed authentication result, via the SDK 114, to the processing network 110, at 352.

In response, the processing network 110 retrieves the user profile from the FIDO data structure 120 for the user 104 (e.g., based on the device ID, etc.) and verifies, at 354, the signature on the authentication result based on the second public key, i.e., public_key_2. When the authentication result is verified, the processing network 110 returns, at 356, the authentication result to the ACS 116.

In turn, the ACS 116 returns, at 358, an authentication response or ARes to the first party 102, or specifically the MPI associated with the first party 102, via the directory server of the processing network 110 (consistent with the 3-D Secure™ protocol/specification flow). The first party 102 then continues to seek authorization of the transaction, whereby one or more values from the ARes is included in the authorization request which is transmitted to the issuer institution 108, via processing network 110.

The method 300 is described with reference to the processing network 110 being enabled for FIDO authentication. In an alternate method, the processing network 110 is not enabled for FIDO authentication, and instead, relies on the issuer institution 108 for FIDO authentication (e.g., using the first key pair, etc.).

In such an example method, the processing network 110 requests the list registration from the issuer institution 108, whereby registered devices are identified. Subsequently, the processing network 110 returns the list of registered devices to the ACS 116. As above, the ACS 116 then cooperates with the first party 102 to display the one or more registered devices to the user 104, at the mobile device 106. The user 104 then selects one of the register devices, which in this example, is the mobile device 106. The selection of the registered device is returned from the mobile device 106, via the first party 102, to the ACS 116.

The ACS 116 requests the processing network 110 to authenticate the user 104 at the mobile device 106, which is the selected registered device. The request includes the identifier of the selected device, i.e., the mobile device 106, and other data associated with the transaction (e.g., identifier of the transaction, name of the first party 102, amount, etc.). In response, the processing network 110 requests the issuer institution 108 to authenticate the user 104. Next, the issuer institution 108 request user authentication as a push notification to the mobile device 106. The push notification may include data associated with the transaction (e.g., identifier of the transaction, name of the first party 102, amount, etc.).

At the mobile device 106, a flag or banner is displayed at the mobile device 106 to the user 104, which may included an indicator of a request for authentication and one or more details about the transaction for which authentication is requested (e.g., “Authenticate to make $50 purchase at Store,” etc.). When the user 104 selects the flag or banner, the mobile device 106 (via the application 112) solicits an authentication of the user 104 for purposes of the initiated transaction. The authentication input may include a biometric, a PIN, a password, or suitable input, etc. for purposes of authentication. In response, the user 104 complies. The mobile device 106 captures the authentication input and authenticate the user 104 based on the authentication input. For example, the mobile device 106 may compare a facial image captured by a camera input device of the mobile device 106 with a reference biometric included therein. The, the mobile device 106 compiles and signs an authentication result with the first private key, i.e., private_key_1. The mobile device 106 then transmits signed authentication results to the issuer institution 108.

Notwithstanding the above, it should be appreciated that when the FIDO authentication of the issuer institution 108 is leveraged, the above QR and operating-system based authentication schemes may be implemented consistent with the description above (yet directed to the issuer institution 108).

In response, the issuer institution 108 retrieves the user profile from the FIDO data structure 118 for the user 104 (e.g., based on the device ID, etc.) and verifies the signature on the authentication result based on the first public key, i.e., public_key_1. When the authentication result is verified, the issuer institution 108 returns the authentication result to the processing network 110, which in turn, provides the authentication result to the ACS 116.

In turn, the ACS 116 returns an authentication response or ARes to the first party 102, or specifically the MPI associated with the first party 102, via the directory server of the processing network 110 (consistent with the 3-D Secure™ protocol/specification flow). The first party 102 then continues to seek authorization of the transaction, whereby one or more values from the ARes is included in the authorization request which is transmitted to the issuer institution 108, via processing network 110.

In view of the above, the systems and methods and computer-readable storage media herein uniquely provide for extending authentication from a third party (e.g., the issuer institution 108, etc.) in connection with transaction specific network traffic, as part of an enhanced authentication challenge flow (e.g., the 3-D Secure™ protocol/specification flow, etc.).

In particular, in various embodiments, FIDO authentication is streamlined over prior iterations of the same, especially within the biometric payment field (e.g., as part of the assertion step during checkout, etc.). The FIDO authentication described above, in certain embodiments, permits authentication without a separate attestation/enrollment. That is, the enrollment is integrated in the enrollment, for FIDO authentication, of an application specific to a third party, such as, for example, an issuer (or issuer institution). The FIDO authentication is then integrated into enhanced authentication, seamlessly, for transactions, and specifically, biometric transactions. This provides a complete technical solution to leverage an existing login scheme (e.g., associated with an application, etc.) to authenticate in connection with other operations (e.g., biometric pay through a challenge in the 3-D Secure™ protocol/specification flow, etc.).

The above alleviates the barrier of a separate application specific to biometric pay, for example, and/or a separate, additional enrollment of the user for FIDO authentication. In this way, the functionality of an application is preserved for its native intent and extended, for example, through an SDK and shared information (e.g., the mappings, registered devices, etc.), from the processing network in the above examples, which serves to streamline adoption of a flexible end-to-end authentication solution, with limited impact on the applications functionality exposed to the user.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations as recited herein and/or in the following claims, including, for example (and without limitation): (a) receiving an authentication request associated with a transaction to an account, from an access control server (ACS), the authentication request including an account number for the account; (b) requesting authentication of a user of the account, from an issuer of the account, at a mobile device; (c) receiving an authentication result, from the mobile device, which is signed by a private key; (d) verifying the signed authentication result, based on a public key associated the mobile device; and/or (c) returning the authentication result, to the ACS, in response to the authentication request.

As will further be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations as recited herein and/or in the following claims, including, for example (and without limitation): (a) receiving an authentication request associated with a transaction to an account, from an access control server (ACS), the authentication request including an account number for the account; (b) transmitting a request for authentication to a mobile device of the user, the authentication request including one of a quick response (QR) code and/or a operating system-based authentication identifier; (c) receiving an authentication result, from the mobile device, which is signed by a private key specific to the processing network; (d) verifying the signed authentication result, based on a public key received from the mobile device, associated with a device ID of the mobile device, and specific to the processing network; and/or (c) returning the authentication result, to the ACS, in response to the authentication request.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9, and so forth.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for extending authentication from a third party, the method comprising:
receiving, at a computing device of a processing network, an authentication request associated with a transaction to an account, from an access control server (ACS), the authentication request including an account number for the account;
requesting, by the computing device, authentication of a user of the account, from an issuer of the account, at a mobile device;
receiving, by the computing device, an authentication result, from the mobile device, which is signed by a private key;
verifying, by the computing device, the signed authentication result, based on a public key associated the mobile device; and
returning, by the computing device, the authentication result, to the ACS, in response to the authentication request.

2. The computer-implemented method of claim 1, wherein requesting an authentication notification includes requesting a push notification, from the issuer, to an application included in the mobile device of the user, the application specific to the issuer.

3. The computer-implemented method of claim 1, wherein the application includes a software development kit (SDK) specific to the processing network.

4. The computer-implemented method of claim 1, further comprising:
receiving, from the issuer, a mapping of the account number to the device ID; and
storing the mapping in a user profile associated with the user in a data structure.

5. The computer-implemented method of claim 1, further comprising:
receiving the public key, from the mobile device, via an application included in the mobile device, the application specific to the issuer; and
storing the public key and a device ID for the mobile device in the user profile of a data structure.

6. The computer-implemented method of claim 5, further comprising, prior to verifying the signed authentication result, retrieving the public key from a data structure based on a device ID of the mobile device.

7. The computer-implemented method of claim 1, further comprising:
identifying one or more registered devices for the account, based on the account number; and
returning a list of the identified one or more registered devices to the ACS; and
wherein requesting authentication from the issuer is based on a selection, by the user, of the mobile device from the one or more registered devices.

8. A computer-implemented method for extending authentication from a third party, the method comprising:
receiving, at a computing device of a processing network, an authentication request associated with a transaction to an account, from an access control server (ACS), the authentication request including an account number for the account;
transmitting, by the computing device, a request for authentication to a mobile device of the user, the authentication request including one of a quick response (QR) code and/or a operating system-based authentication identifier;
receiving, by the computing device, an authentication result, from the mobile device, which is signed by a private key specific to the processing network;
verifying, by the computing device, the signed authentication result, based on a public key received from the mobile device, associated with a device ID of the mobile device, and specific to the processing network; and
returning, by the computing device, the authentication result, to the ACS, in response to the authentication request.

9. The computer-implemented method of claim 8, further comprising identifying the mobile device based on an account number for the account from the authentication request and a mapping of the account number to a device ID of the mobile device in a user profile for the user.

10. The computer-implemented method of claim 8, further comprising receiving the public key, from the mobile device, via an application included in the mobile device, the application specific to the issuer; and
storing the public key in the user profile.

11. The computer-implemented method of claim 8, further comprising:
in response to the authentication request, identifying one or more registered devices for the account, based on the account number; and
returning a list of the identified one or more registered device to the ACS; and
wherein transmitting the request for authentication is based on a selection, by the user, of the mobile device from the one or more registered devices.

12. A non-transitory computer-readable storage medium comprising executable instructions, which when executed by at least one processor, cause the at least one processor to:
receive an authentication request associated with a transaction to an account, from an access control server (ACS), the authentication request including an account number for the account;
request authentication of a user of the account, from an issuer of the account, at a mobile device;
receive an authentication result, from the mobile device, which is signed by a private key;
verify the signed authentication result, based on a public key associated the mobile device; and
return the authentication result, to the ACS, in response to the authentication request.

13. The non-transitory computer-readable storage medium of claim 12, wherein the executable instructions, when executed by the at least one computing device to request an authentication notification, cause the at least one computing device to request a push notification, from the issuer, to an application included in the mobile device of the user, the application specific to the issuer.

14. The non-transitory computer-readable storage medium of claim 12, wherein the application includes a software development kit (SDK) specific to the processing network.

15. The non-transitory computer-readable storage medium of claim 12, wherein the executable instructions, when executed by the at least one computing device, further cause the at least one computing device to:
receive, from the issuer, a mapping of the account number to the device ID; and
store the mapping in a user profile associated with the user in a data structure.

16. The non-transitory computer-readable storage medium of claim 12, wherein the executable instructions, when executed by the at least one computing device, further cause the at least one computing device to:
receive the public key, from the mobile device, via an application included in the mobile device, the application specific to the issuer; and
store the public key and a device ID for the mobile device in the user profile of a data structure.

17. The non-transitory computer-readable storage medium of claim 16, wherein the executable instructions, when executed by the at least one computing device, further cause the at least one computing device to, prior to verifying the signed authentication result, retrieve the public key from a data structure based on a device ID of the mobile device.

18. The non-transitory computer-readable storage medium of claim 12, wherein the executable instructions, when executed by the at least one computing device, further cause the at least one computing device to:
identify one or more registered devices for the account, based on the account number;
return a list of the identified one or more registered devices to the ACS; and
request authentication from the issuer based on a selection, by the user, of the mobile device from the one or more registered devices.
